(19) United States
(12) Patent Application Publication
(10) Pub. No.: US 2013/0025048 A1
(43) Pub. Date: Jan. 31, 2013

(54) Comfortdraw

(71) Applicant: Tommy D. Pruett, Copperas Cove, TX (US)

(72) Inventor: Tommy D. Pruett, Copperas Cove, TX (US)

(21) Appl. No.: 13/192,307

(22) Filed: Jul. 27, 2011

(51) Int. Cl. A61G 7/10

(52) U.S. Cl. 5/81.1 HS

(57) ABSTRACT

A mechanical aid to be used for transferring or sliding a patient that is bedridden, handicapped, paralyzed, surgically incapacitated, or otherwise unable to move without assistance in a hospital bed. This mechanical aid may be operable by a single individual attendant. For these purposes, the mechanical aid includes a box frame having an aperture that easily slides over a hospital bed headboard and includes threaded mounts at each end of the box frame allowing the device to be adjustable and securable to all sides hospital bed headboards. The box frame may cooperate with a shaft which may be geared and attachable that may be rotated bi-directionally by a motor. The shaft may include spools to gather and release straps as the shaft rotates bi-directionally. The straps may include a hook at the end of the strap which may attach to a draw sheet and may cooperate with loops which may attach to a draw sheet. Once the hooks are attached to the loops, the draw sheet will slide the patient to the proper position in a hospital bed.

### FIELD OF THE INVENTION

The present invention relates to hospital beds and more particularly to a device to automatically move a patient on a hospital bed.

### BACKGROUND

Transferring patients between beds or from a litter to a bed can be a very traumatic experience and can even lead to additional injury especially for patients who have a back injury or broken bone. It is difficult if not impossible to align the patient with the proper position in the target bed. Consequently, the patient usually has to be moved towards the headboard after the patient has been transferred to the bed. This usually involves lifting the patient or pulling on the patient shoulders to place the patient in the proper position on the bed. This can also cause problems for the personnel moving the patient. The personnel moving the patient may be injured especially when the patient has a significant weight.

It is desirable to provide a device which can move the patient without the aid of hospital personnel and without further injuring the patient.

### SUMMARY

A device to move a patient in a bed may include a headboard frame to detachably connect to a headboard of the bed, a motor to extend and retract a strap and a draw pad connected to the strap to move the patient on the bed.

The motor may be connected to a shaft to extend and retract the strap, and the shaft may be connected to a spool to extend and retract the strap.

The shaft may be connected to a bearing being mounted to the headboard frame, and the device may include a set screw to engage the headboard of the bed.

The set screw may be positioned on a sidewall of the headboard frame, and the draw sheet may be connected to the strap by a fastener.

The fastener may include a hook, and the fastener may include a loop.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a perspective view of the Comfortdraw device of the present invention;

FIG. 2 illustrates a perspective view of the headboard frame and the motor shaft of the present invention;

FIG. 3 illustrates an exploded view of the spool and shaft of the present invention;

FIG. 4 illustrates a partial view of the spool and shaft of the present invention;

FIG. 5 illustrates a perspective view of the motor and shaft of the present invention;

FIG. 6 illustrates a perspective view of the motor and shaft of the present invention;

FIG. 7 illustrates a top view of the portion of the headboard frame and the motor of the present invention;

FIG. 8 illustrates an end view of the headboard frame of the present invention;

FIG. 9 illustrates a perspective view of the headframe of the present invention;

FIG. 10 illustrates a top view of the headboard and headboard frame of the present invention;

FIG. 11 illustrates a top view of a control operating switch of the present invention;

FIG. 12 illustrates a side view of the control operating switch of the present invention;

FIG. 13 illustrates a top view of the draw sheet and loop of the present invention;

FIG. 14 illustrates a top view of the strap, shaft, spool and hook and loop of the present invention;

FIG. 15 illustrates a top view of the present invention; and

FIG. 16 illustrates a perspective view of the present invention.

### DETAILED DESCRIPTION

The present invention may include a combination of at least two devices that may work in conjunction with one another to allow a single person to automatically pull a patient up in a hospital bed towards the headboard without assistance from a second individual and without endangering or hurting the individual or patient in any manner whatsoever. The present invention may include a Comfortdraw headboard machine and a Comfortdraw draw sheet. The present invention works equally well from either the right side or the left side of the bed of the patient, and the present invention may include multiple troll sheet hook loops (to eliminate the need for a rod to be inserted in order to attach pull straps).

The present invention including the bed equipment may be formed from wood, plastic, fiberglass, aluminum, metal, alloy, steel, or other suitable material.

The present invention including the Comfortdraw draw sheet might be a quilted top and bottom fabric, cotton, silk, rayon, nylon, polyester, blended cotton, denim, or other suitable material which may facilitate sliding.

The elongated strap of the present invention may be formed from plastic, leather, fabric, nylon or other suitable material.

The present invention including the motor to move the Comfortdraw draw sheet may be operated with variable speeds and may include slow and crawl in order to make the Comfortdraw safe to operate.

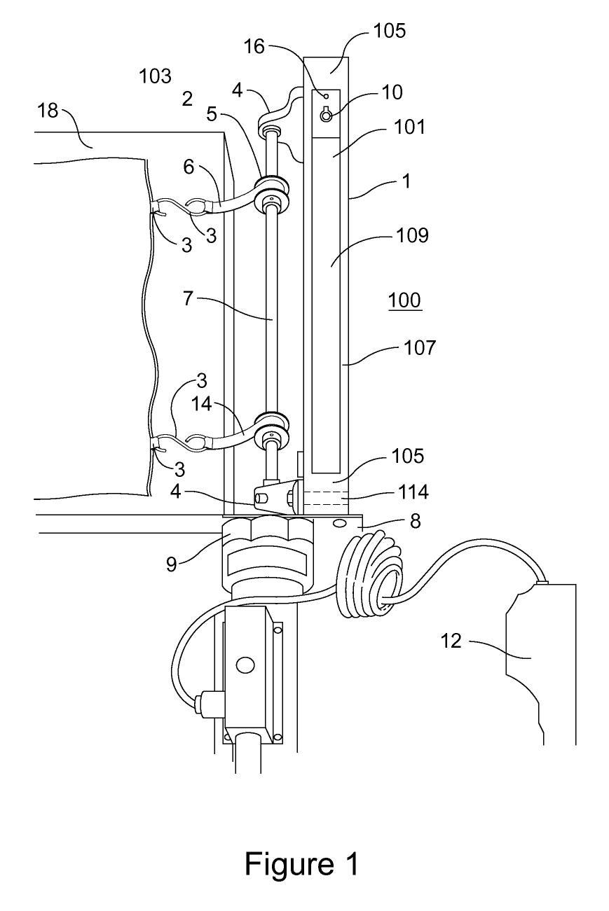

FIG. 1 illustrates a perspective view of the Comfortdraw device 100 and illustrates the headboard frame 1 which may include a front wall 103 which may be opposed to a back wall 107 and which may be connected to a side wall 105 which may be connected to the back wall 107. The front wall 103, the back wall 107 and the side wall 105 define a central aperture 101 which may extend through the headboard frame 1 and which may be adapted to allow the headboard frame 1 to be placed over the headboard 109 of a hospital bed.

FIG. 1 additionally illustrates a motor 9 which may be a variable speed electric motor connected to a motor mount bracket 8 which may be connected to the sidewall 105 of the headboard frame 1. The motor may bi-directionally rotate a motor shaft 7 which may be rotatably connected to a first bearing 4 at the proximate end of the shaft 7 and which may be rotatably connected to a second bearing 4 at the distal end of the shaft 7. The first bearing 4 and the second bearing 4 may be connected to the front wall 103 of the headboard frame 1. The shaft 7 may include a first spool 5 and a second spool 5 which may be in a spaced relationship with respect to the first spool 5. The first spool 5 and the second spool 5 may be slidably adjustable on a shaft 7 and may include a set screw to lock the first spool 5 and the second spool 5 in position on the shaft 7.

FIG. 1 illustrates a threaded set screw 10 which may include a padded knob 137 to cooperate with the headboard 109 so the set screw 10 is turned until the headboard frame 1 is securely connected to the headboard 109.

Consequently, the headboard frame 1 is detachably connected to the headboard 109.

FIG. 1 illustrates a remote operating switch 12 to control the speed, turn off and turn on the motor 9 and illustrates a safety sensor 11 to turn off the motor 9 if the draw sheet 2 approaches at a predetermined distance to the headboard frame 1.

FIG. 1 illustrates a bolt sleeve 132 and mounting holes 154 for installation purposes.

FIG. 1 additionally illustrates that the straps 14 (for example a comfortdraw integrated strap system) which may be flexible or which may be rigid extend or retract in accordance with the bidirectional rotation of the spool 5.

FIG. 1 illustrates a draw sheet 2 which may be sufficiently large in order to order to carry the patient and move the patient over the mattress 18 of the bed. The draw sheet 2 may be connected to the straps 6 by a fastener 3 which may include a hook and a loop. Aperture 16 may be used for mounting the headboard frame 1 to the headboard 109.

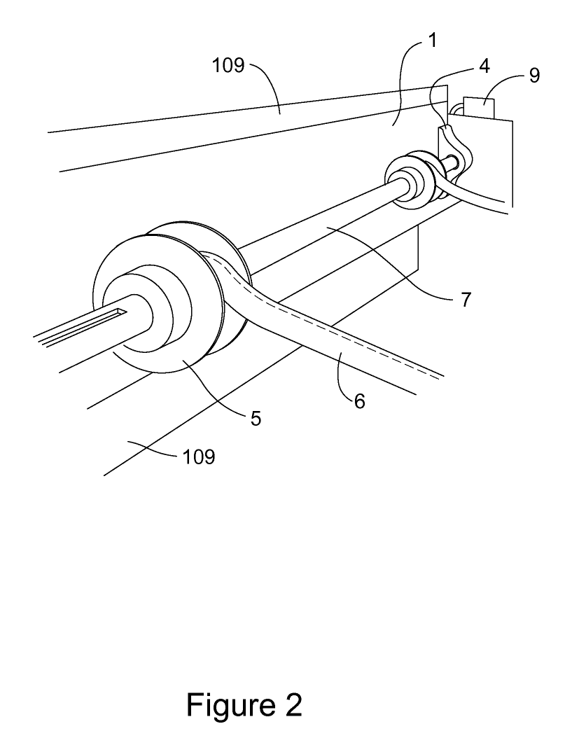

FIG. 2 illustrates a perspective view of the headboard frame 1 which has been placed onto the headboard 109 and illustrates the motor shaft 7 which may be mounted on the bearings 4 and which may be in a spaced relationship with the headboard frame 1. FIG. 2 additionally illustrates the motor 9 which may bi-directionally rotate the motor shaft 7 and which bi-directionally rotates the spool 5 which moves the straps 6.

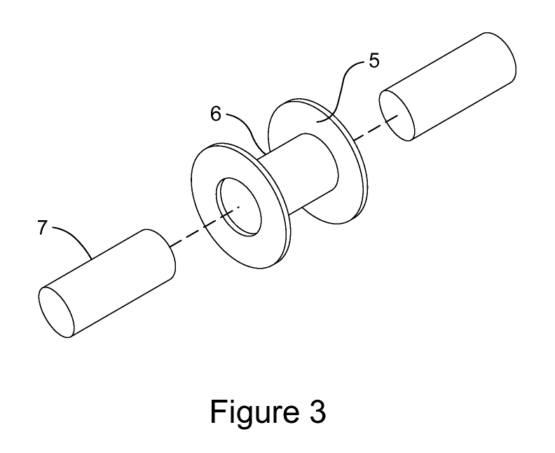

FIG. 3 illustrates an exploded view of the spool 5 which may be positioned on the shaft 7 and may include a strap 6 to move the draw sheet 2 (not shown in FIG. 3).

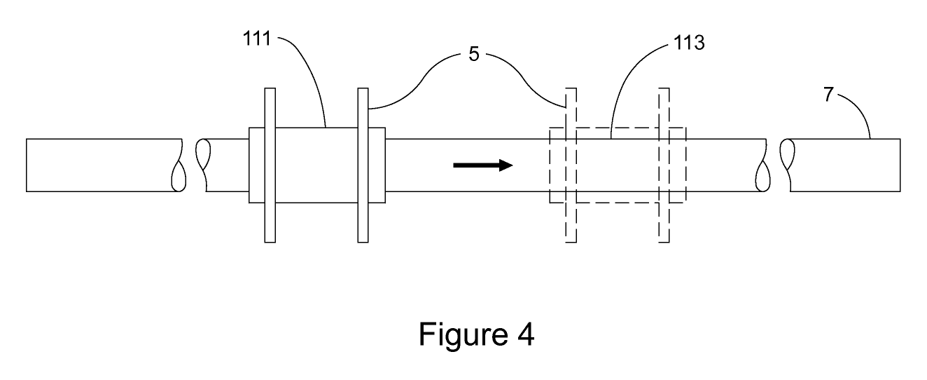

FIG. 4 illustrates a sectional view of the spool 5 mounted on the shaft 7 which may move from a first position 111 to a second position 113.

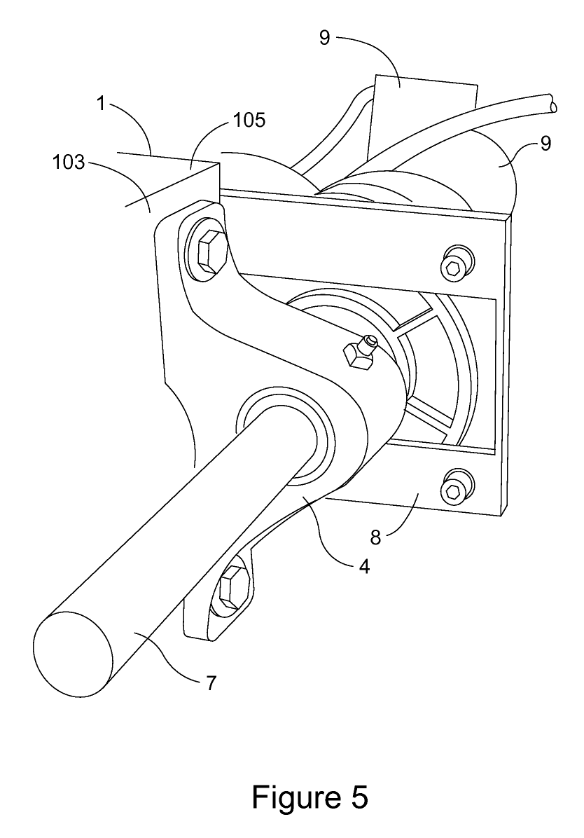

FIG. 5 illustrates a perspective view and illustrates the front wall 103 of the headboard frame 1 and the bearing 4 which may be mounted on the front wall 103 to support the shaft 7 which may be connected to the motor 9. FIG. 5 additionally illustrates the motor mount bracket 8 which may be a bracket to mount the motor 9 to the sidewall 105 of the headboard frame 1.

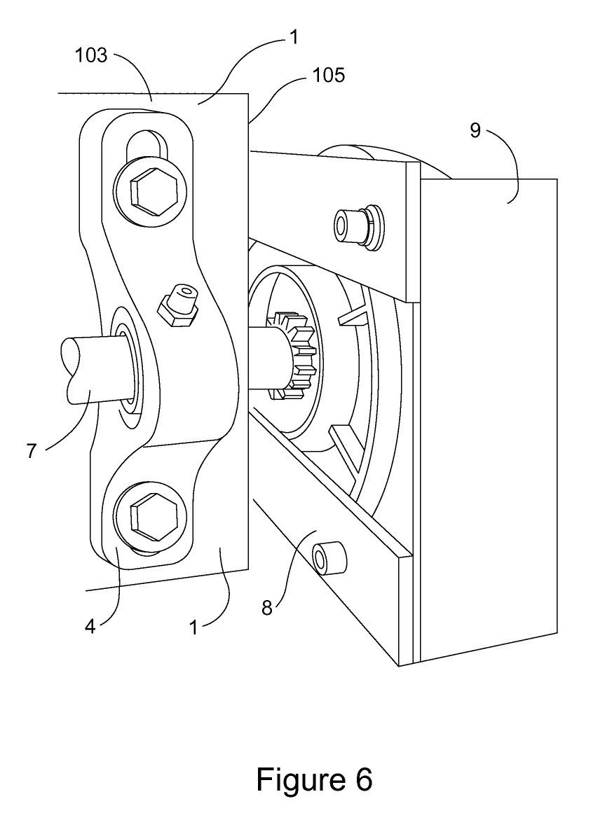

FIG. 6 illustrates a perspective view and illustrates the front wall 103 of the headboard frame 1 and the bearing 4 which may be mounted on the front wall 103 to support the shaft 7 which may be connected to the motor 9.

FIG. 6 additionally illustrates the motor mount bracket 8 which may be a bracket to mount the motor 9 to the sidewall 105 of the headboard frame 1.

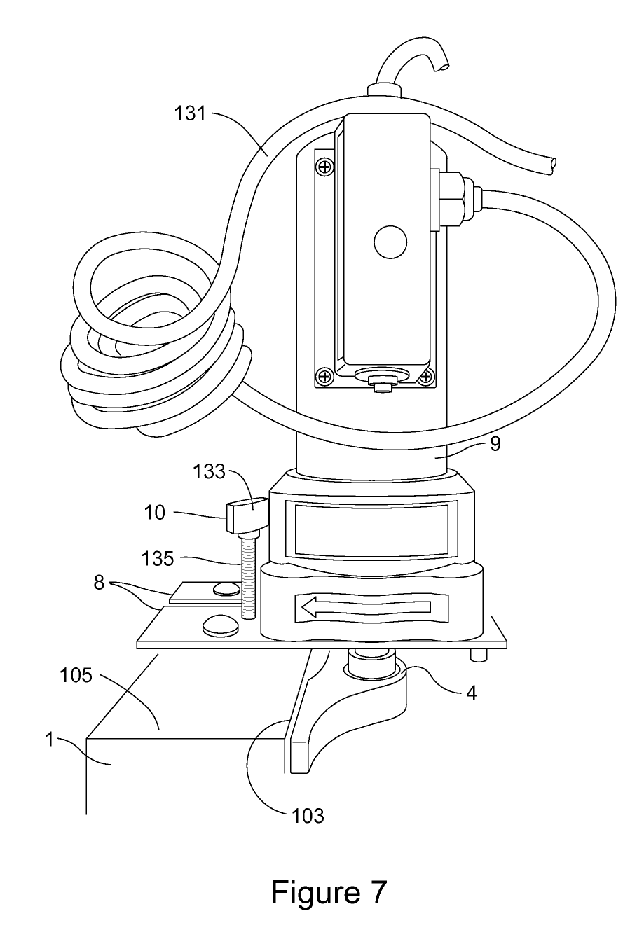

FIG. 7 illustrates a top view of the motor 9 and headboard frame 1 of the present invention and illustrates the motor mount bracket 8 to mount the motor 9 on the sidewall 105 of the headboard frame 1. Furthermore, FIG. 7 illustrates the bearing 4 to connect to the front wall 103. The motor 9 receives electric power through the electric cord 131.

FIG. 7 illustrates a set screw 10 which may include a handle 133 and a threaded shaft 135 which may extend into the sidewall 105, and the set screw 10 may be rotated.

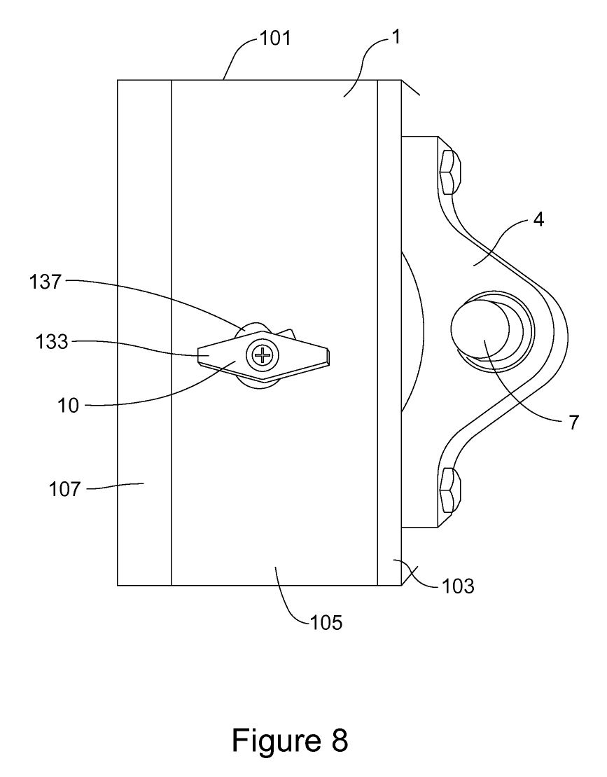

FIG. 8 illustrates an end view of the headboard frame 1 which may include the sidewall 105, the front wall 103, the back wall 107, and the central aperture 101. FIG. 8 additionally illustrates the bearing 4 which may be mounted on the front wall 103 to provide bearing support for the motor shaft 7. FIG. 8 additionally illustrates the set screw 10 which may be turned by the handle 133 and may bi-directionally rotate by virtue of a sleeve 137 which may be threaded to cooperate with the threads of the set screw 10.

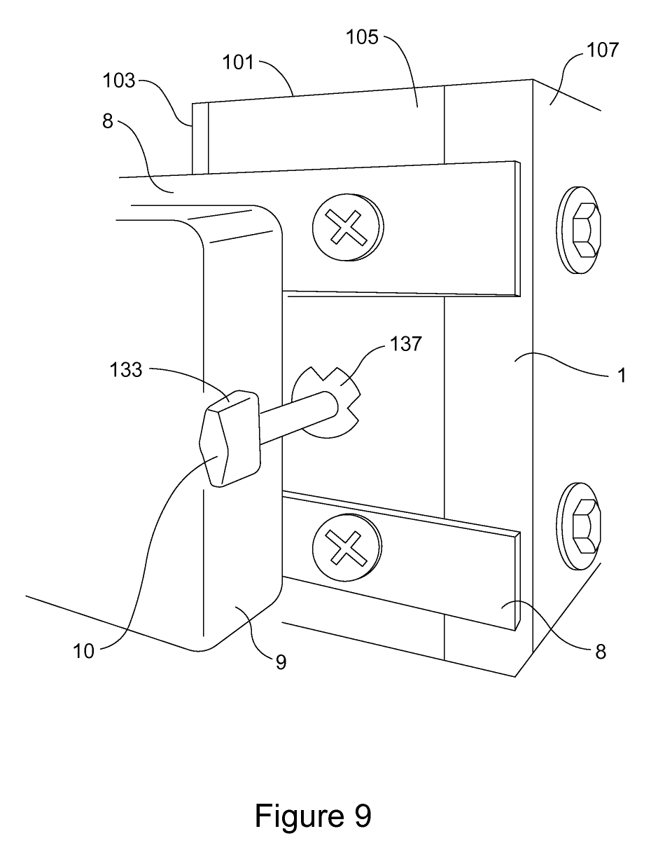

FIG. 9 illustrates a perspective view of the headboard frame 1 which may include the sidewall 105, the front wall 103, the back wall 107, and the central aperture 101. FIG. 9 additionally illustrates the set screw 10 which may be turned by the handle 133 and may bi-directionally rotate by virtue of a sleeve 137 and which may extend into the sidewall 105 and which may be threaded to cooperate with the threads of the set screw 10.

FIG. 9 additionally illustrates the motor mounting bracket 8 which may be connected to the sidewall 105 and to the motor 9.

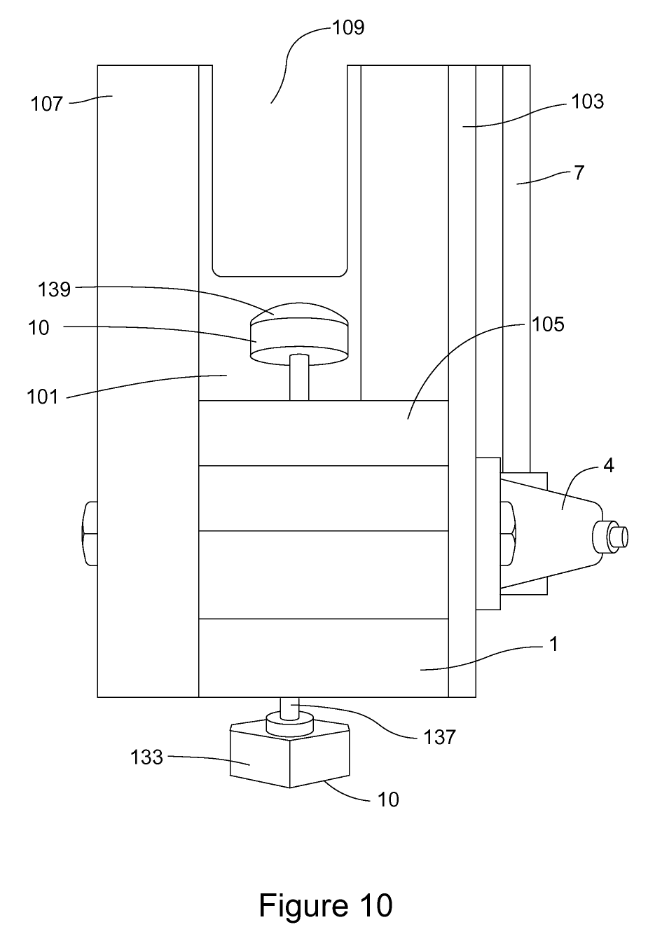

FIG. 10 illustrates a top view of the headboard frame 1 and the headboard 109 of a bed which may be a hospital bed. FIG. 10 shows a sectional view of the end of the headboard frame 1, and a substantial mirror of the end of the headboard frame 1 is positioned on opposing end of the headboard frame 1.

FIG. 10 illustrates the front wall 103, the sidewall 105, the back wall 107 and a central aperture 101 and illustrates the bearing 4 mounted on the front wall 103 and the motor shaft 7 which extends through the bearing 4 and rotates bi-directionally. FIG. 10 additionally illustrates that the set screw 10 may extend through the sidewall 105 and may rotate on the sleeve 137 by the user rotating the handle 133 and illustrates a padded knob 139 mounted on the distal end of the set screw 10 to obtain a frictional fit with the headboard 109 to stabilize the headboard frame 1 while the motor 9 (not shown in FIG. 10) is operating.

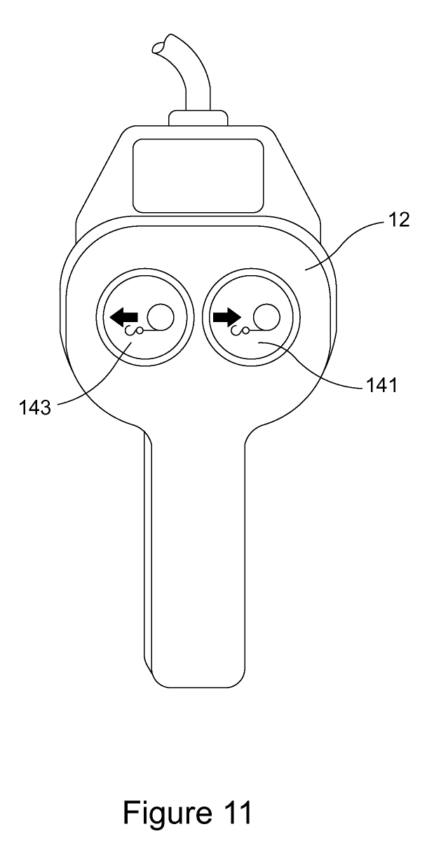

FIG. 11 illustrates a top view of the control operating switch 12 to control the operation of the motor 9 and the bi-directional rotating shaft 7 and illustrates a first control knob 141 and a second control knob 143. The first control knob 141 controls the operation of the shaft 7 and spool 5 in a first direction and controls the speed of the shaft 7 and spool 5, and the second control knob 143 controls the operation of the shaft 7 and spool 5 in a second direction and controls the speed of the shaft 7 and spool 5.

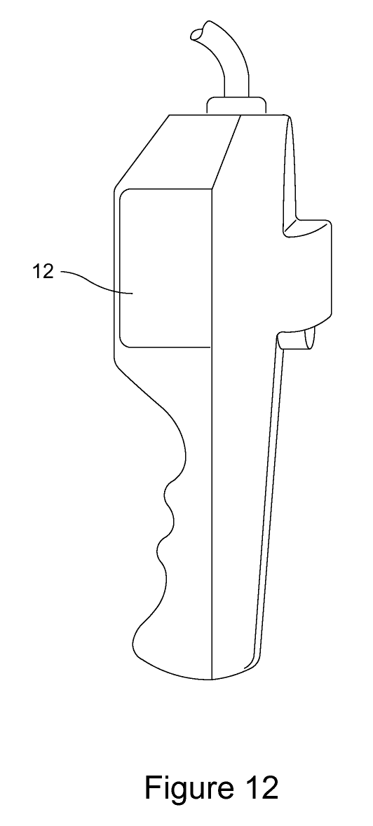

FIG. 12 illustrates a side view of the control operating switch 12.

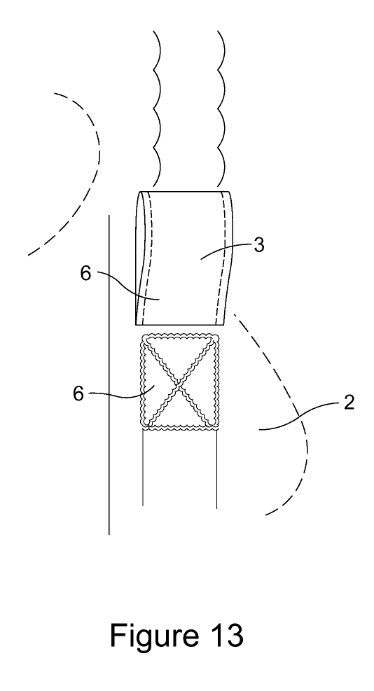

FIG. 13 illustrates a top view of a draw sheet reinforcement assembly with a strap 6 sewn into the draw sheet 2 by stitching across, diagonally and along the perimeter of the comfortdraw integrated strap system below the loop fasteners 3.

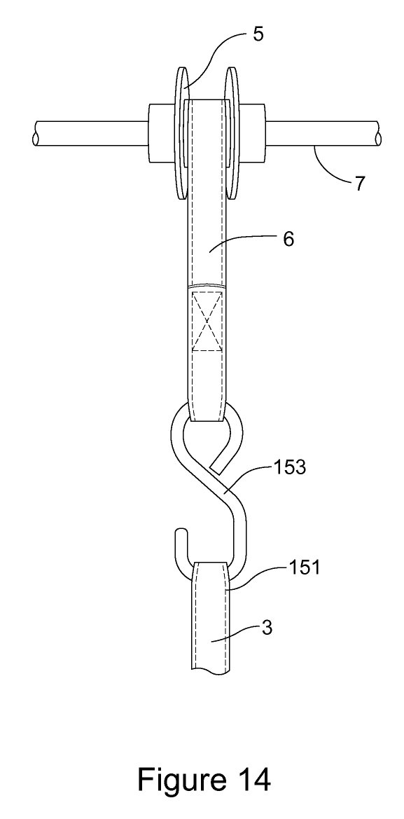

FIG. 14 illustrates a top view of the spool 5 mounted on the shaft 7 and cooperating with the strap 6 and shows the strap 6 connected to the fastener 3 which may include the hook 153 and loop 151.

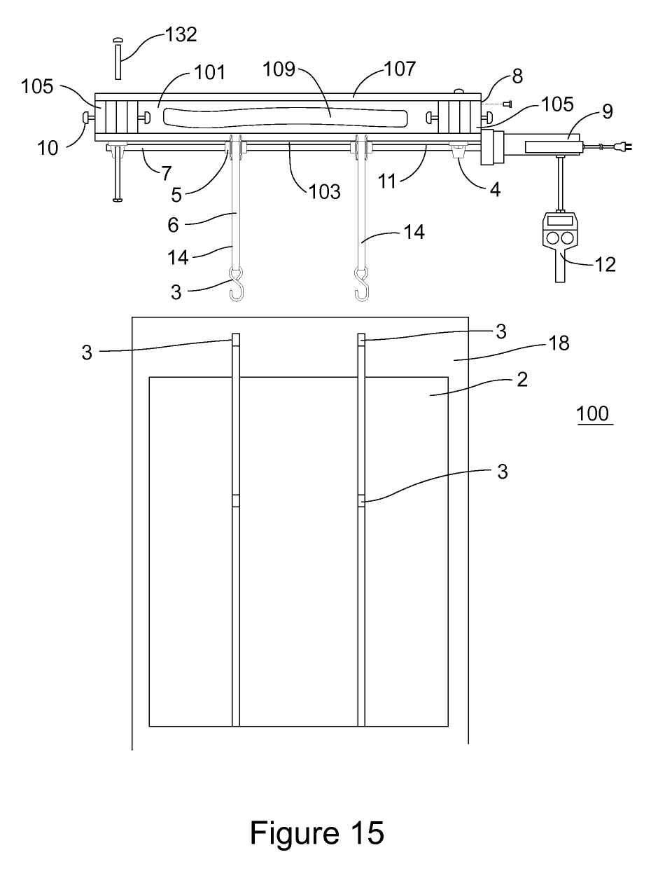

FIG. 15 illustrates a perspective view of the Comfortdraw device 100 and illustrates the headboard frame 1 which may include a front wall 103 which may be opposed to a back wall 107 and which may be connected to a side wall 105 which may be connected to the back wall 107. The front wall 103, the back wall 107 and the side wall 105 define a central aperture 101 which may extend through the headboard frame 1 and which may be adapted to allow the headboard frame 1 to be placed over the headboard 109 of a hospital bed.

FIG. 15 additionally illustrates a motor 9 which may be a variable speed electric motor connected to a motor mount bracket 8 which may be connected to the sidewall 105 of the headboard frame 1. The motor may bi-directionally rotate a motor shaft 7 which may be rotatably connected to a first bearing 4 at the proximate end of the shaft 7 and which may be rotatably connected to a second bearing 4 at the distal end of the shaft 7. The first bearing 4 and the second bearing 4 may be connected to the front wall 103 of the headboard frame 1. The shaft 7 may include a first spool 5 and a second spool 5 which may be in a spaced relationship with respect to the first spool 5. The first spool 5 and the second spool 5 may be slidably adjustable on a shaft 7 and may include a set screw to lock the first spool 5 and the second spool 5 in position on the shaft 7.

FIG. 15 illustrates a threaded set screw 10 which may include a padded knob to cooperate with the headboard 109 so the set screw 10 is turned until the headboard frame 1 is securely connected to the headboard 109.

Consequently, the headboard frame 1 is detachably connected to the headboard 109.

FIG. 15 illustrates a remote operating switch 12 to control the speed, turn off and turn on the motor 9 and illustrates a safety sensor 11 to turn off the motor 9 if the draw sheet 2 approaches at a predetermined distance the headboard frame 1.

FIG. 15 illustrates a bolt sleeve 132.

FIG. 15 additionally illustrates that the comfortdraw integrated strap system 14 which may be flexible or which may be rigid extend or retract in accordance with the bi-directional rotation of the spool 5.

FIG. 15 illustrates a draw sheet 2 which may be sufficiently large in order to order to carry the patient and move the patient over the mattress 18 of the bed. The draw sheet 2 may be connected to the straps 14 by a fastener 3 which may include a hook and a loop.

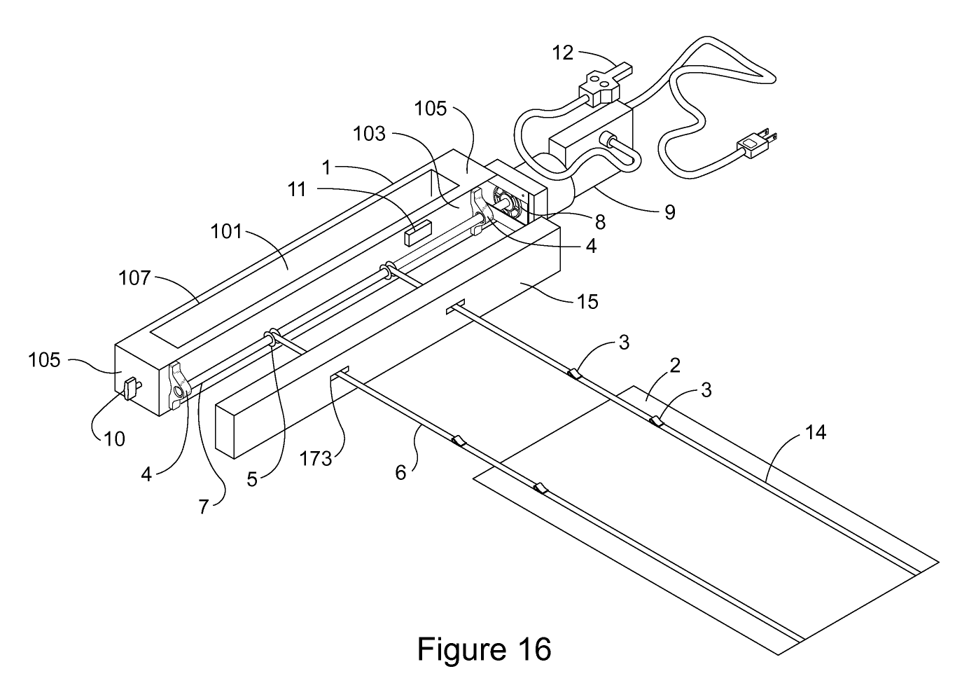

FIG. 16 illustrates a perspective view of the Comfortdraw device 100 and illustrates the headboard frame 1 which may include a front wall 103 which may be opposed to a back wall 107 and which may be connected to a side wall 105 which may be connected to the back wall 107. The front wall 103, the back wall 107 and the side wall 105 define a central aperture 101 which may extend through the headboard frame 1 and which may be adapted to allow the headboard frame 1 to be placed over the headboard 109 (not shown in FIG. 16) of a hospital bed.

FIG. 16 additionally illustrates a motor 9 which may be a variable speed electric motor connected to a motor mount bracket 8 which may be connected to the sidewall 105 of the headboard frame 1. The motor may bi-directionally rotate a motor shaft 7 which may be rotatably connected to a first bearing 4 at the proximate end of the shaft 7 and which may be rotatably connected to a second bearing 4 at the distal end of the shaft 7. The first bearing 4 and the second bearing 4 may be connected to the front wall 103 of the headboard frame 1. The shaft 7 may include a first spool 5 and a second spool 5 which may be in a spaced relationship with respect to the first spool 5. The first spool 5 and the second spool 5 may be slidably adjustable on a shaft 7 and may include a set screw to lock the first spool 5 and/or the second spool 5 in position on the shaft 7.

FIG. 16 illustrates a threaded set screw 10 which may include a padded knob to cooperate with the headboard 109 so the set screw 10 is turned until the headboard frame 1 is securely connected to the headboard 109.

Consequently, the headboard frame 1 is detachably connected to the headboard 109.

FIG. 16 illustrates a remote operating switch 12 to control the speed, turn off and turn on the motor 9 and illustrates a safety sensor 11 which may be mounted on the front wall 103 to turn off the motor 9 if the draw sheet 2 approaches at a predetermined distance the headboard frame 1. FIG. 16 additionally illustrates a cover 15 to cover the spool 5 and shaft 7 and may include an aperture 173 for the strap 6.

FIG. 16 additionally illustrates that the comfortdraw integrated strap system 14 which may be flexible or which may be rigid extend or retract in accordance with the bi-directional rotation of the spool 5.

FIG. 16 illustrates a draw sheet 2 which may be sufficiently large in order to order to carry the patient and move the patient over the mattress 18 of the bed. The draw sheet 2 may be connected to the straps 14 by a fastener 3 which may include a hook and a loop. FIG. 16 illustrates that the fastener 3 may be positioned at various locations on the draw sheet 2 for example at the midsection of the draw sheet 2.

The Comfortdraw of the present invention can be used from either the right side or the left side of the bed, may include auto stop sensors to stop the motor 9, provides for a single person installation, provides for operation from a standard 120 V AC outlet, provides for movement of large and small individuals, provides multi-speed capability, provides for multiple connections on the draw sheet 2, provides for easy installation, provides for quick attachment to a hospital bed, provides a bidirectional rotation with motor 9, and eliminates the need to lift a patient. The present invention could be used electrically or manually, provides solid construction and could be built from a multitude of materials.

With respect to institutional use, the present invention provides an improved staff to patient ratio for example a single nurse can pull the patient up, provides for reduced care per patient, prevents injuries from nursing staff, allows a single nurse to provide for patients to be moved up in bed before feeding time, reduces the number of call light signals for patients needing to be pulled up in bed, reduces time and staff per patient and helps eliminate worker compensation claims. The present invention reduces injuries on a patient requiring repositioning of the patient to the head of the bed, provides a better quality of care for patients, allows the nurses to be able to spend more time on other tasks for the patient, helps manage staff workload. The present invention conveniently attaches to the existing hospital beds, helps to eliminate workers compensation claims, reduces injuries on patients being repositioned or transferred to the head of the bed, maintains a better quality of care for patients since nursing staff can better use their time for more tasks for the patient, and the comfort draw pad is washable and reusable. The present invention provides less strain on staff with bariatric patients, helps reduce fear on staff with patients with tube feeding or Trachs or IVs, pressure sores, splints, braces and cast or broken bones, provides a continuous motion instead of two or three short pulls to get to the head of the bed, eliminates lowering the head of patient all the way down and elevating the feet all the way up to do a lift which eliminates shear forces on the patient, eliminates jolting and jarring, eliminates physical movement, reduces pulling on the patient physically, it results in transferring, repositioning and pulling to be comfortable and pleasant, it is less stressful mentally and physically, more convenient for the patient to be pulled up in bed, increases pain management, allows the patient to be properly positioned in the bed more often, more comfortable for the patient to be at the head of the hospital bed to reduce pressure points, at feeding time, the patient would be positioned up in the bed for meals to reduce choking and encourage proper swallowing, the present invention is especially beneficial in pain management for burn victims, and it allows patients to remain at home longer due to less stress on caregiver back and time.

The present invention aids in preventing strains, pulls, tears, shear force, out of position for proper load redistribution, speeds up work time, individually operated, reduces staff to patient ratio, reduces physical and mental exhaustion, lessons the probability to lose work due to injury, helps to maintain establishing income and extends nursing staffing work life, allows elderly caregivers (spouse) to keep loved ones at home, allows for sitting for longer period of time, allows the patient to reposition, transfer, pull, slide, patient up in bed by themselves at any time day.

The present invention mechanically eliminates and reduces weight load capacity for any individual transferring, repositioning, pulling or sliding a patient up in a hospital bed.

The present invention assists in an individual maintaining the medical requirement that a patient with tube feeding, tracheotamy remains at the head of the hospital bed at approximately 30° in the hospital bed so that the patients are less likely to aspire (this is accomplished by transferring, repositioning, sliding or pulling the patient up in a hospital bed with the device of the present invention. The patient may be bedridden, handicapped, paralyzed, surgically incapacitated, amputated, and immobile, contracted, or unable to move without assistance or other types of uses.

The head board frame 1 allows for quick and easy installation with a hospital bed by sliding the headboard frame 1 over the headboard 109. The headboard frame 1 may be designed to move up and down a bed headboard 109 so that a desired position can be achieved for the headboard frame 1 and it can be semi-permanently secured for use over the headboard 109.

The draw sheet 2 maybe formed by sewing two pieces of fabric which may be of like size, together with a working load strap which may be securely affixed between the two sheets of fabric. The draw sheet 2 may be placed under a bedridden patient and hooked to the straps 6 so the patient will be safely and comfortably pulled up in the bed when the machine is turned on. The draw sheet hook loops 3 which may be attached to the straps 6 to provide the mechanism for the draw sheet 2 to be pulled.

The bearing 4 are mounted to the headboard frame 1 and provide a mechanism for the shaft to bi-directionally rotate to allow the straps 6 to extend down the bed to be attached to the draw sheet loop 3 and then pull the patient to the head of the bed.

The schools may be used to guide the straps 6. The spools 5 can be positioned along the shaft 7 and secured to the shaft 7.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A device to move a patient in a bed, comprising:
a headboard frame to detachably connect to a headboard of the bed;
a motor to extend and retract a strap;
a draw pad connected to the strap to move the patient on the bed.

2) A device to move a patient in a bed as in claim 1, wherein the motor is connected to a shaft to extend and retract the strap.

3) A device to move a patient in a bed as in claim 2, wherein the shaft is connected to a spool to extend and retract the strap.

4) A device to move a patient in a bed as in claim 2, wherein the shaft is connected to a bearing being mounted to the headboard frame.

5) A device to move a patient in a bed as in claim 1, wherein the device includes a set screw to engage the headboard of the bed.

6) A device to move a patient in a bed as in claim 5, wherein the set screw is positioned on a sidewall of the headboard frame.

7) A device to move a patient in a bed as in claim 1, wherein the draw sheet is connected to the strap by a fastener.

8) A device to move a patient in a bed as in claim 7, wherein the fastener includes a hook.

9) A device to move a patient in a bed as in claim 7, wherein the fastener includes a loop.
